(19) United States
(12) Patent Application Publication
(10) Pub. No.: US 2007/0282863 A1
(43) Pub. Date: Dec. 6, 2007

(54) METHOD, SYSTEM, AND PROGRAM PRODUCT FOR PROVIDING PROXIES FOR DATA OBJECTS

(76) Inventors: Ritchard L. Schacher, Cary, NC (US); Adam R. Clarke, Raleigh, NC (US); Matthew J. Hicks, Morrisville, NC (US); Joseph J. Kubik, Cary, NC (US)

Correspondence Address: HOFFMAN WARNICK & DALESSANDRO LLC, 75 STATE ST, 14TH FLOOR, ALBANY, NY, 12207, US

(21) Appl. No.: 11/420,868

(22) Filed: May 30, 2006

(51) Int. Cl. G06F 17/00

(52) U.S. Cl. 707/100

(57) ABSTRACT

The present invention provides a method, system, and program product for providing proxies for data objects such as SDOs. Specifically, under the present invention, a reference between two data objects is identified. The two data objects could reside in different data graphs, or they could reside in separate branches of a common data graph. In any event, a reference object will be inserter/provided into the branch or data graph containing the reference. The reference object is typically inserted at runtime of an application utilizing the data graph(s), and functions as a proxy for the reference. To this extent, the reference object could be an instance of the data object being referenced, or the reference itself.

### CROSS-REFERENCE TO RELATED APPLICATION

This application is related in some aspects to the commonly-owned application entitled “Method, System, and Program Product for Managing Adapter Association for a Data Graph of Data Objects”, which is assigned attorney docket number RSW920050217US1, was filed on (to be provided), and was assigned Ser. No. (to be provided), the entire contents of which are herein incorporated by reference. This application is also related in some aspects to the commonly-owned application entitled “Method to Support Data Streaming in Service Data Objects Graphs”, which is assigned attorney docket number RSW920050210US1, was filed on (to be provided), and was assigned Ser. No. (to be provided), the entire contents of which are herein incorporated by reference.

### BACKGROUND OF THE INVENTION

1. Field of the Invention

The present invention generally relates to a method, system, and program product for providing proxies for data objects such as Service Data Objects (SDOs). Specifically, the present invention allows reference objects to be inserted into data graphs as proxies for references between data objects in different data graphs or data graph branches.

2. Related Art

The Service Data Object (SDO) specification and the Eclipse Modeling Framework (EMF) reference implementation define a common set of Application Programming Interfaces (APIs) and data objects that allow for a common programming methodology across heterogeneous data repositories. The SDO specification allows for disconnected data graphs to be retrieved, changed, and then persisted by means of a “mediator.” Although, the mediator specification is not yet defined, the role defined for the mediator is to take any data graph changes and persist them to other systems such as repositories, backend systems, etc. One of the shortcomings of the SDO specification is that it does not support the notion of proxies between data objects. That is, proxy support is not available in the specification and objects cannot be introduced into a data graph at runtime. However, in most application modeling scenarios, the concept of containment and aggregate relationships are very common. For example, a data object in a data graph may reference another data object in the same or another data graph.

In order to effectively support aggregate relationship modeling, a proxy model would be very advantageous. In addition to supporting aggregate relationships, supporting proxies would be very important for performance. Since there is currently no concept of a proxy object, the mediator is always required to resolve the full object for references. Such an approach is non-scalable and inefficient.

In view of the foregoing, there exists a need for a solution that solves at least one of the deficiencies in the existing art.

### SUMMARY OF THE INVENTION

In general, the present invention provides a method, system, and program product for providing proxies for data objects such as SDOs. Specifically, under the present invention, a reference between two data objects is identified. The two data objects could reside in different data graphs, or they could reside in separate branches of a common data graph. In any event, a reference object will be inserted/provided into the branch or data graph containing the reference. The reference object is typically inserted at runtime of an application utilizing the data graph(s), and functions as a proxy for the reference. To this extent, the reference object could be an instance of the data object being referenced, or the reference itself. In any event, a Boolean identifier or the like could be provided that indicates whether the reference object contains the data or the reference. In addition, listeners or adapters (such as those provided by EMF) could be provided to monitor the data objects for any changes.

A first aspect of the present invention provides a method for providing proxies for data objects, comprising: obtaining at least one data graph having hierarchically arranged data objects; identifying a reference from a first data object to a second data object of the at least one data graph; and providing a reference object in the at least one data graph having the first data object as a proxy for the reference.

A second aspect of the present invention provides a system for providing proxies for Service Data Objects (SDOs), comprising: a system for obtaining at least one SDO data graph having hierarchically arranged SDOs; a system for identifying a reference from a first SDO to a SDO of the at least one SDO data graph; and a system for providing a reference object in the at least one SDO data graph having the first SDO as a proxy for the reference.

A third aspect of the present invention provides a program product stored on a computer readable medium for providing proxies for data objects, the computer readable medium comprising program code for causing a computer system to perform the following steps: obtaining at least one data graph having hierarchically arranged data objects; identifying a reference from a first data object to a second data object of the at least one data graph; and providing a reference object in the at least one data graph having the first data object as a proxy for the reference.

A fourth aspect of the present invention provides a method for deploying an application for providing proxies for data objects, comprising: providing a computer infrastructure being operable to: obtain at least one data graph having hierarchically arranged data objects; identify a reference from a first data object to a second data object of the at least one data graph; and provide a reference object in the at least one data graph having the first data object as a proxy for the reference.

Therefore, the present invention provides a method, system, and program product for providing proxies for data objects.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a physical model showing a reference from a first data object to a second data object in accordance with the present invention.

FIG. 2 depicts a logical model showing a reference object being inserted as a proxy for the reference of FIG. 1 in accordance with the present invention.

FIG. 3 depicts a set of data graphs in which one data object references another data object in accordance with the present invention.

FIG. 4 shows the data graphs of FIG. 3 after a first type of reference object has been added as a proxy for the reference in accordance with the present invention.

FIG. 5 shows the data graphs of FIG. 3 after a second type of reference object has been added as a proxy for the reference in accordance with the present invention.

FIG. 6 depicts a more specific computerized implementation in accordance with the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The present invention provides a method, system, and program product for providing proxies for data objects such as SDOs. Specifically, under the present invention, a reference between two data objects is identified. The two data objects could reside in different data graphs, or they could reside in separate branches of a common data graph. In any event, a reference object will be inserted/provided into the branch or data graph containing the reference. The present invention can also embody the use of a “development time” physical/logical model transformation, where the proxy class is inserted into the model and the proxy class represents a shell with information to retrieve the real object. The reference object is typically inserted at runtime of an application utilizing the data graph(s), and functions as a proxy for the reference. To this extent, the reference object could be an instance of the data object being referenced, or the reference itself. In any event, a Boolean or the like could be provided that indicates whether the reference object contains the data or the reference. In addition, listeners or adapters (such as those provided by EMF) could be provided to monitor the data objects for any changes.

It should be understood in advance that the present invention can be implemented in the context of a single data graph or multiple data graphs. In addition, it should be understood that although a typical embodiment involves SDO data graphs and SDO data objects, this need not be the case.

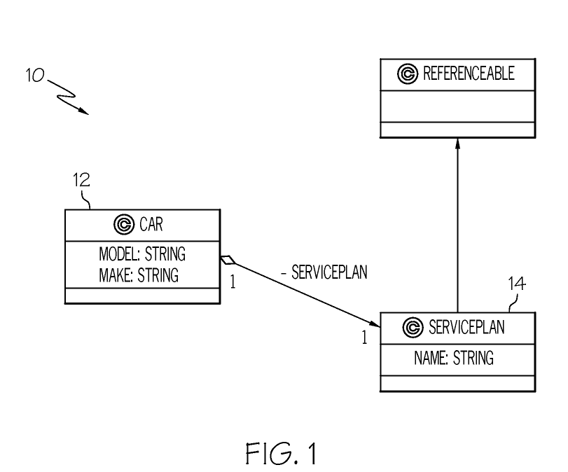

Referring now to FIG. 1, a physical model 10 showing a reference from a first data object 12 to a second data object 14 is shown. As can be seen, this example includes a car (i.e., automobile) data object 12 referencing a service plan data object 14. To this extent, data object 12 could be a word processing file that has an embedded link/reference to spreadsheet file or the like. One problem with physical model 10 is that there is currently no way to proxy the reference to data object 14. That is, prior to the present invention, there was no way to provide a reference object in the data graph (The box labeled referenceable represents a base class from which other referenceable types could be defined). The present invention addresses this shortcoming by transforming the physical model 10 into a logical model. This transformation allows for the introduction of lightweight proxy types in the hierarchy that is used as the proxies for all types that could be referenced. The original types are then changed to extend from the proxy types. The proxy types generally include a unique identifier property that is used when a true proxy is needed. In addition to creating the proxy types, all of the relationships pointing to original types will be changed to “point to” (i.e., modeled against) the proxy types. This allows references to be set with a proxy type, and also with the original type since it extends from the proxy type. In addition, a proxy property is introduced on the main “reference type.” The proxy property can be set to true if the reference object contains a proxy type (reference), or false if the reference object actually contains an instance of the original type (referenced data object 14). This logical model processing allowed us to maintain the strongly typed relationships in the model without forcing the mediator to retrieve the full objects when they were not required.

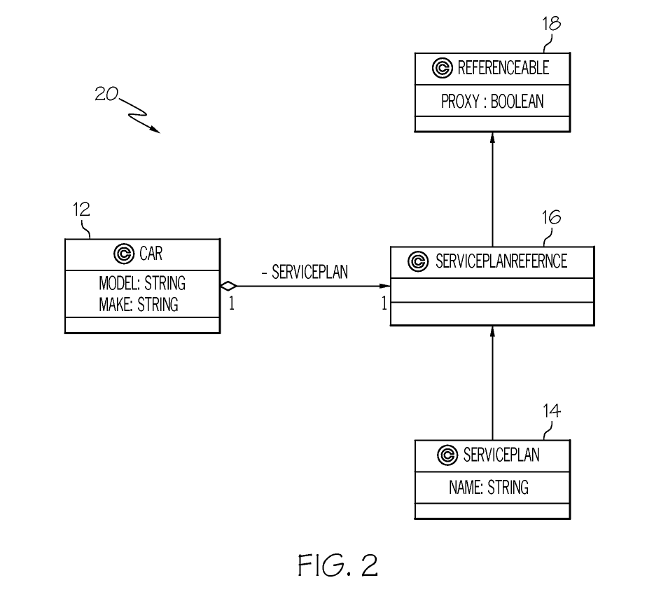

Referring to FIG. 2, a logical model 20 after transformation from physical model 10 (FIG. 1) and insertion of reference object 16 is shown. Specifically, as depicted, reference object 16 has been inserted as a proxy 18 for data object 14. Under the present invention, reference object 16 can include the reference to data object 14, or an instance of data object 14. To this extent, proxy 18 can be a Boolean proxy that is set to true if reference object 16 includes the reference to data object 14, or false if reference object 16 actually contains an instance of data object 14.

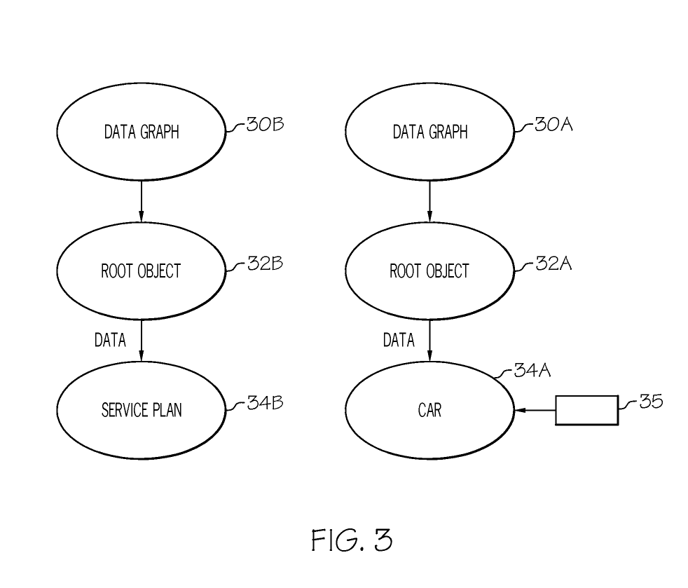

Referring to FIG. 3, the teachings of the present invention are illustrated in conjunction with data graphs 30A-B. As mentioned above, data graphs 30A-B are typically SDO data graphs whereby each data object 32A-B and 34A-B are SDOs (however, this need not be the case). It should also be understood that although multiple data graphs 30A-B are shown, the present invention could be implemented with a single data graph having multiple branches in which data object 34A appears in one branch while data object 34B appears in another branch. In any event, each data graph 30A-B typically contains a hierarchy of data objects 32A-B and 34A-B in a parent-child relationship. In the example in FIG. 3, data object 34A has a reference to data object 34B. As such, data objects 34A-B have a non-containment relationship.

Under the present invention, a reference object will be added to data graph 30A (or from the branch in which data object 34A resides in the case that data objects 34A-B are provided in a single data graph) as a proxy for the reference to data object 34B. This process is aided by the introduction of one or more adapters or listeners (a single adapter 35 is shown in FIG. 3 for brevity purposes), on data graph 30A (and optionally data graph 30B) to maintain the serialization integrity thereof. Specifically, since non-containment relationships cannot be used across data graphs without breaking serialization, adapter 35 is used to detect all additions or other changes to non-containment relationships. Upon detection of a change, if the data object 34B resided in a different data graph 30B than the adapter 35's data graph 30A (as shown in FIG. 3), the adapter 35 will actually discard the specified data object 34B to be set, and will create a proxy representation of that data object 34B with the proxy property to true. Adapter 35 will then store the proxy in an internal containment relationship on data graph 30A and set the proxy, now contained in data graph 30A, as the reference. If a data object in the same data graph 30A (i.e., in a different branch of data graph 30A) is set in a non-containment property, the adapter 35 will allow the reference to be made and would not construct a new proxy object. This behavior ensures that all objects were always contained within the data graph and allows the graph to be serializable.

Whenever a new object from a different data graph 30B is added to a non-containment relationship, adapter 35 would create a new proxy or reference object of the same type (only copying the universal unique identifier) and store that reference object in an internal containment relationship on the data graph 30A's root object 32A. Then, instead of setting the specified data object 34B in the property, it would set the new “proxy” reference object. This solves two problems by allowing data objects from other graphs to be set in the non-containment relationships and also, by only creating a reference object. This avoids all of the data integrity issues involved with making a deep copy of the referenced data object 30B itself. It should be understood that a single adapter 35 has been shown for brevity purposes only. As such, an adapter 35 could be provided for (e.g., associated with) each data object 32A-B and 34A-B of each data graph 30A-B.

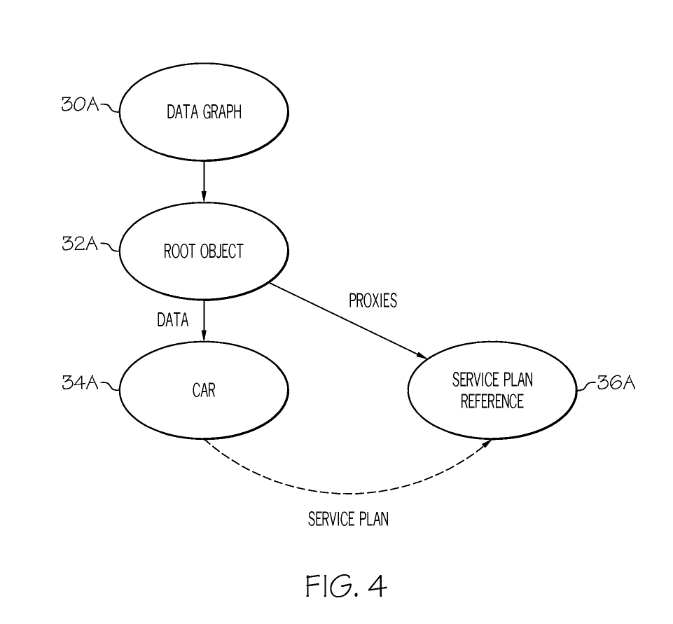

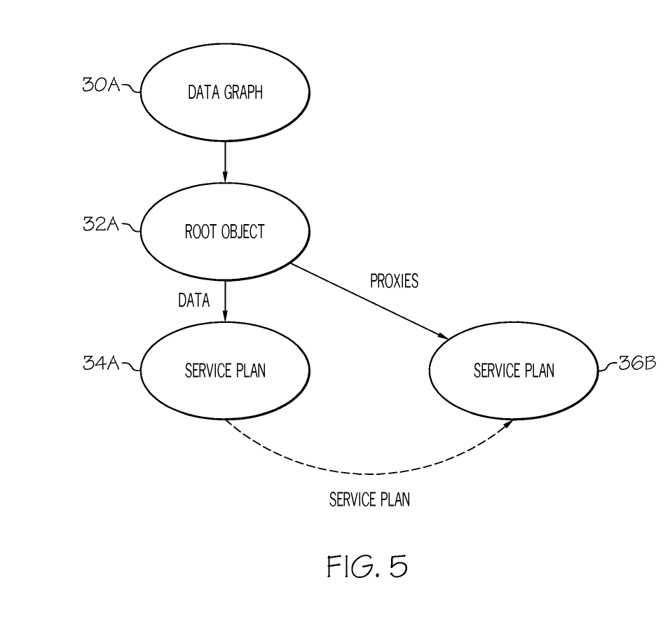

Referring to FIG. 4, data graph 30A is shown as modified according to the present invention. As depicted, reference object 36A has been added as a proxy for data object 34B (FIG. 3). In the embodiment shown in FIG. 4, reference object 36A contains the reference to data object 34A. That is, reference object 36A contains the universal identifier corresponding to data object 34A. Referring to FIG. 5, another embodiment is shown in which a reference object 36B has been added in a similar fashion. However, in FIG. 5, reference object 36B includes an actual instance of data object 34A.

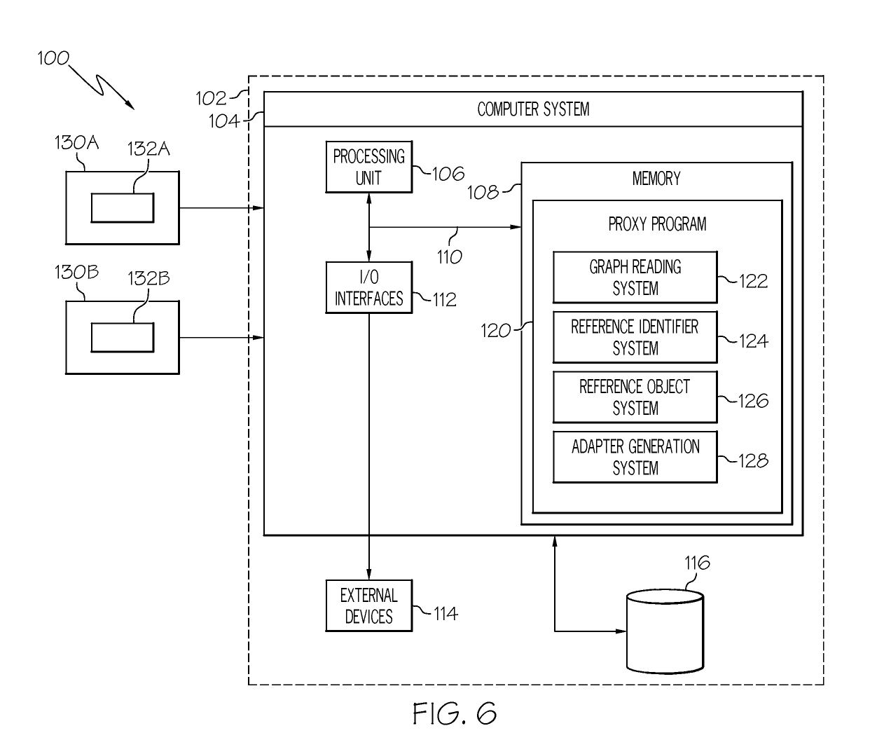

Referring now to FIG. 6, a more detailed diagram of a computerized implementation 100 of the present invention is shown. As depicted, implementation 100 includes a computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to provide proxies for data objects.

As shown, computer system 104 includes a processing unit 106, a memory 108, a bus 110, and input/output (I/O) interfaces 112. Further, computer system 104 is shown in communication with external I/O devices/resources 114 and storage system 116. In general, processing unit 106 executes computer program code, such as proxy program 120, which is stored in memory 108 and/or storage system 116. While executing computer program code, processing unit 106 can read and/or write data to/from memory 108, storage system 116, and/or I/O interfaces 112. Bus 110 provides a communication link between each of the components in computer system 104. External devices 114 can comprise any devices (e.g., keyboard, pointing device, display, etc.) that enable a user to interact with computer system 104 and/or any devices (e.g., network card, modem, etc.) that enable computer system 104 to communicate with one or more other computing devices such as server 130.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process steps of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, I/O interfaces 112 can comprise any system for exchanging information with one or more external devices 114. Still further, it is understood that one or more additional components (e.g., system software, math co-processing unit, etc.) not shown in FIG. 6 can be included in computer system 104. However, if computer system 104 comprises a handheld device or the like, it is understood that one or more external devices 114 (e.g., a display) and/or storage system(s) 116 could be contained within computer system 104, not externally as shown.

Storage system 116 can be any type of system (e.g., a database) capable of providing storage for information under the present invention such as data graphs, data objects, reference objects, adapter data, etc. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). Although not shown, additional components, such as cache memory, communication systems, system software, etc., may be incorporated into computer system 104.

Shown in memory 108 of computer system 104 is proxy program 120, which includes graph reading system 122, reference identifier system 124, reference object system 126, adapter generation system 128. These systems provide the functionality of the present invention discussed above. It should be understood that although not shown, other programs such as components of a distributed application will likely be loaded on computer system 104.

In any event, assume that data object 132A of data graph 130A references data object 132B on data graph 130B. Under the present invention, graph reading system 122 will read data graphs 130A-B into memory 108. This process can also be referred to as a deserialization process as known in the art. In any event, the reference to data object 132B from data object 132A will be detected/identified by reference identifier system 124. In response, reference object system 126 will insert/provide a proxy object in data graph 130A as a proxy for the reference. As indicated above, the proxy object can include the reference to data object 132B (e.g., based on a UUID), or an actual instance of data object 132B. Whether the reference object contains the reference or the instance can be indicated based on a setting of the proxy property (e.g., true vs. false). In addition, the reference object is typically added to data graph 130A at runtime of an application (not shown) that utilizes data graphs 130A-B. In any event, FIG. 6 also depicts adapter generation system 128, which provides EMF adapters or listeners to monitor data objects for changes. In a typical embodiment, adapter generation system 128 will generate and associate an adapter or the like with each data object 132A-B of data graphs 130A-B. Although not a direct part of the present invention, the steps involved with generating an adapter (e.g., by an adapter factor, etc.) can be found in the above-incorporated patent application.

It should be understood that although FIG. 6 depicts multiple data graphs 130A-B, this need not be the case. That is, the present invention could be utilized in conjunction with references between data objects of different branches of a single data graph. Thus, data graph 130A-B could actually represent two different branches in a common data graph. It should also be understood that the teachings of the present invention could be implemented on a stand-alone computer system 104 as shown, or in a distributed environment.

While shown and described herein as a method and system for providing proxies for data objects, it is understood that the invention further provides various alternative embodiments. For example, in one embodiment, the invention provides a computer-readable/useable medium that includes computer program code to enable a computer infrastructure to provide proxies for data objects. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 6) and/or storage system 116 (FIG. 6) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to provide proxies for data objects. In this case, the service provider can create, maintain, support, etc., a computer infrastructure, such as computer infrastructure 102 (FIG. 6) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for providing proxies for data objects. In this case, a computer infrastructure, such as computer infrastructure 102 (FIG. 6), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 104 (FIG. 6), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for providing proxies for data objects, comprising:
obtaining at least one data graph having hierarchically arranged data objects;
identifying a reference from a first data object to a second data object of the at least one data graph; and
providing a reference object in the at least one data graph having the first data object as a proxy for the reference.

2. The method of claim 1, wherein the at least one data graph is a Service Data Object (SDO) data graph, and wherein the first data object and the second data object are SDOs.

3. The method of claim 1, wherein at least one data graph comprises a first data graph and a second data graph, and wherein the first data object resides in the first data graph and the second data object resides in the second data graph.

4. The method of claim 1, wherein at least one data graph comprises a single data graph, and wherein the first data object resides in a first branch of the single data graph and the second data object resides in a second branch of the single data graph.

5. The method of claim 1, further comprising providing an adapter on the at least one data graph to monitor changes to the first data object.

6. The method of claim 1, wherein a relationship between the first data object and the second data object comprises a non-containment relationship.

7. The method of claim 1, wherein the proxy comprises a Boolean proxy.

8. The method of claim 1, wherein the reference object is provided at runtime of an application that utilizes the at least one data graph.

9. The method of claim 1, wherein the method transforms a logical model into a physical model by inserting proxy classes as reference targets, and wherein the reference targets replace original reference targets.

10. A system for providing proxies for Service Data Objects (SDOs), comprising:
a system for obtaining at least one SDO data graph having hierarchically arranged SDOs;
a system for identifying a reference from a first SDO to a SDO of the at least one SDO data graph; and
a system for providing a reference object in the at least one SDO data graph having the first SDO as a proxy for the reference.

11. The system of claim 10, wherein at least one SDO data graph comprises a first SDO data graph and a second SDO data graph, and wherein the first SDO resides in the first SDO data graph and the second SDO resides in the second SDO data graph.

12. The system of claim 10, wherein the reference object comprises an instance of the second SDO.

13. The system of claim 10, wherein the reference object comprises the reference to the second data object.

14. The system of claim 10, further comprising a system for providing an adapter on the at least one SDO data graph to monitor changes to the first SDO.

15. The system of claim 10, wherein the proxy comprises a Boolean proxy.

16. A program product stored on a computer readable medium for providing proxies for data objects, the computer readable medium comprising program code for causing a computer system to perform the following steps:
obtaining at least one data graph having hierarchically arranged data objects;
identifying a reference from a first data object to a second data object of the at least one data graph; and
providing a reference object in the at least one data graph having the first data object as a proxy for the reference.

17. The program product of claim 16, wherein at least one data graph comprises a first data graph and a second data graph, and wherein the first data object resides in the first data graph and the second data object resides in the second data graph.

18. The program product of claim 16, wherein at least one data graph comprises a single data graph, and wherein the first data object resides in a first branch of the single data graph and the second data object resides in a second branch of the single data graph.

19. The program product of claim 16, wherein the computer readable medium further comprises program code for causing the computer system to perform the following step: providing an adapter on the at least one data graph to monitor changes to the first data object.

21. A method for deploying an application for providing proxies for data objects, comprising:
providing a computer infrastructure being operable to:
obtain at least one data graph having hierarchically arranged data objects;
identify a reference from a first data object to a second data object of the at least one data graph; and
provide a reference object in the at least one data graph having the first data object as a proxy for the reference.
